(19) United States
(12) Patent Application Publication
(10) Pub. No.: US 2024/0170798 A1
(43) Pub. Date: May 23, 2024

(54) Valve Device and Battery Housing with such a Valve Device

(71) Applicant: Illinois Tool Works Inc., Glenview, IL (US)

(72) Inventors: Melanie SINDEL, Nürnberg (DE); Jan MÜLLER, Würzburg (DE)

(21) Appl. No.: 18/517,347

(22) Filed: Nov. 22, 2023

(30) Foreign Application Priority Data
Nov. 22, 2022 (DE) 10 2022 130 902.9
Dec. 9, 2022 (DE) 10 2022 132 878.3
Feb. 17, 2023 (DE) 10 2023 104 033.2
Mar. 20, 2023 (DE) 10 2023 106 967.5
Nov. 15, 2023 (DE) 10 2023 131 815.2

(51) Int. Cl. H01M 50/325; H01M 50/308

(52) U.S. Cl. CPC H01M 50/325; H01M 50/308; H01M 50/3425

(57) ABSTRACT

Disclosed is a valve apparatus, in particular for a battery housing of an electric vehicle, is provided. It includes a base body formed from a soft component and having a first sealing portion for sealing against a first component and a connecting-sealing portion for sealing and connecting to a second component, and wherein the base body bounds a passageway and includes a covering side and a connecting side, a valve element, wherein the valve element is arranged in the region of the passageway of the base body, and a securing element formed from a hard component and having a latch portion, wherein, in a final assembly position, the latch portion is received in the base body so as to limit at least a movement of the connecting-sealing portion of the base body radially inwards in order to thereby secure the final assembly position of the valve apparatus.

### RELATED APPLICATIONS

The present application claims the benefit of German Patent Application No. DE10 2022 130 902.9, filed Nov. 22, 2022, and German Patent Application No. DE10 2022 132 878.3, filed Dec. 9, 2022, and German Patent Application No. DE10 2023 104 033.2, filed Feb. 17, 2023, and German Patent Application No. DE10 2023 106 967.5, filed Mar. 20, 2023, and German Patent Application No. DE10 2023 131 815.2, filed Nov. 15, 2023, the contents of which are hereby incorporated by reference.

### BACKGROUND

A valve is a component for shutting off or controlling the flow of fluids (liquids or gases). In valves, a closure part (e.g. membrane, plate, cone, ball, or needle) is usually moved approximately parallel to the direction of flow or about an axis of rotation transverse to the direction of flow of the fluid. The flow is interrupted in that the closure part is pressed with the sealing surface to a suitably shaped opening, the valve or sealing seat.

A problem addressed by the present disclosure is to provide a valve apparatus as well as a battery housing having such a valve apparatus that is compact and requires only a small design space.

### SUMMARY

The present disclosure relates generally to a valve apparatus and a battery housing, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a schematic, laterally cut view of a valve apparatus according to the disclosure according to a first exemplary embodiment in a state of being sealingly connected to a first component and a second component.

FIG. 2 illustrates a schematic, laterally cut detail view from FIG. 1.

FIG. 3 illustrates a perspective schematic view of a valve apparatus according to the disclosure.

FIG. 4 illustrates a schematic, laterally cut view of the valve apparatus according to the disclosure according to a second exemplary embodiment in a state of being connected to a first component and a second component.

FIG. 5 illustrates a schematic, laterally cut view of the valve apparatus according to the disclosure according to a third exemplary embodiment in a state of being connected to a first component and a second component.

FIG. 6 illustrates a perspective view of a base body of the valve apparatus according to the disclosure according to a fourth exemplary embodiment in the folded state.

FIG. 7 illustrates the base body from FIG. 6 in the unfolded state.

FIG. 8 illustrates a perspective view of a valve device of the valve apparatus.

FIG. 9 illustrates a perspective view of the base body upon connection to a first and a second component.

FIG. 10 illustrates a further perspective view of the base body upon connection to the first and the second component.

FIG. 11 illustrates a perspective view of the valve device and the base body of the valve apparatus in a final assembly position.

FIG. 12 illustrates a perspective, laterally cut view of the final assembly position.

FIG. 13 illustrates a detail view of a connecting region of the valve apparatus to the first and second components.

FIG. 14 illustrates a perspective, laterally cut view of the valve apparatus.

FIG. 15 illustrates a perspective view of the valve device.

FIG. 16 illustrates a detail view of the catching recesses from FIG. 15.

FIG. 17 illustrates a schematic, laterally cut view of a valve apparatus according to the disclosure according to a fifth exemplary embodiment in a final assembly position.

FIG. 18 illustrates a further laterally cut, perspective, schematic view of the valve apparatus in the final assembly position.

FIG. 19 illustrates an aerial view of the valve apparatus from below or from the connecting side.

FIG. 20 illustrates an aerial view of the valve apparatus from above or from the covering side.

FIG. 21 illustrates a schematic, laterally cut view of a first and a second component.

FIG. 22 illustrates a schematic, laterally cut view of a base body of the valve apparatus.

FIG. 23 illustrates a schematic, laterally cut view of a valve element of the valve apparatus and a valve device of the valve element.

FIG. 24 illustrates a schematic, laterally cut view of a securing element of the valve apparatus.

FIG. 25 illustrates a further laterally cut view of the first and the second component.

FIG. 26 illustrates a schematic, laterally cut view of the base body in a state of being connected to the valve element.

FIG. 27 illustrates a schematic, laterally cut view of the securing element.

FIG. 28 illustrates a perspective, exploded view of the valve apparatus and a second component.

FIG. 29 illustrates a perspective view of the base body and the valve element connected thereto, as well as the securing element and the second component.

FIG. 30 illustrates a perspective view of the base body and the valve element in a state of being arranged in the second component, and the securing element.

FIG. 31 illustrates a perspective view of the valve apparatus in a final assembly position while arranged in the second component.

FIG. 32 illustrates a lateral view of a valve apparatus according to the disclosure according to a sixth exemplary embodiment.

FIG. 33 illustrates a schematic, laterally cut perspective view of the valve apparatus according to the sixth embodiment.

FIG. 34 illustrates an aerial view from below of a valve device or a bursting element of the valve apparatus.

FIG. 35 illustrates a schematic, perspective view of a valve apparatus according to the disclosure according to a seventh exemplary embodiment.

FIG. 36 illustrates a schematic, laterally cut view of the valve apparatus according to the disclosure in a final assembly position, in which the valve apparatus is connected to a second component.

FIG. 37 illustrates a schematic aerial view from below or on the connecting side onto the valve apparatus according to the disclosure.

FIG. 38 illustrates a schematic, perspective, laterally cut view of a valve apparatus according to the disclosure according to an eighth exemplary embodiment.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a valve apparatus and a battery housing having such a valve apparatus. A further problem addressed by the present disclosure is to provide an alternative to known valve apparatuses. Another problem addressed by the present disclosure is to provide a valve apparatus that is safe and reliable in operation.

According to the disclosure, a valve apparatus, in particular for a battery housing of an electric vehicle according to a fifth exemplary embodiment, is provided. It comprises a base body formed from a soft component and having a first sealing portion for sealing against a first component and a connecting-sealing portion with a connecting portion for sealing and connecting to a second component, and wherein the base body bounds a passageway and comprises a covering side and a connecting side, a valve element, wherein the valve element is arranged in the region of the passageway of the base body, and a securing element formed from a hard component and having a latch portion, wherein, in a final assembly position, the latch portion is received in the base body so as to limit at least a movement of the connecting portion of the base body radially inwards in order to thereby secure the final assembly position of the valve apparatus.

To connect the valve apparatus according to the disclosure to a second component, the connecting portion of the base body formed from a soft component is provided. By introducing the latch portion of the securing element into the base body, an inward movement of the connecting portion in the radial direction is limited, so that the connecting portion exerts a force acting in the radial direction outwardly on an inner casing wall of an opening of a second component and, in this way, fixes the valve apparatus in the final assembly position.

In addition, the latch portion of the securing element can apply a radially outward force onto the connecting portion such that a retaining force with which the valve apparatus is held in an opening of a second component is increased.

Apparatuses known from the prior art are connected to a carrier component usually by means of a screw connection, a snap connection, or a clip connection or a bayonet fastener.

By contrast, the valve apparatus according to the disclosure comprises the connecting portion of the soft component so that the valve apparatus is securely and reliably connected to a first component.

The valve apparatus is in particular free of catching means or connecting means for connecting to one of the two components.

Thus, according to the present disclosure, a valve apparatus is provided that is free of catching means for connecting to a component and therefore requires a very small design space and is in particular extremely flat in construction.

The valve apparatus is preferably provided for a battery-powered vehicle. Battery valves are used in order to transport gas into and out of a battery or cell.

The valve apparatus according to the disclosure is thus configured in particular for degassing a battery or a cell or a battery pack in the event of a thermal runaway and/or for continuous pressure relief or balancing.

Due to the limited space, it is advantageous for the valve apparatus to be of extremely compact design in and around a cell. As already discussed above, conventional fastening solutions are not suitable for this purpose, because they are built up high due to the fastening means used, in particular.

In the valve apparatus according to the disclosure, only the soft component or the connecting portion of the base body formed from a soft component is provided for this purpose in order to connect the valve apparatus in a space-saving manner to a second component. Furthermore, in the valve apparatus according to the disclosure, the valve apparatus or its base body is provided so as to sealingly connect both a first component, in particular a degassing opening of a cell, and a second component, in particular a second degassing opening of a battery housing. Thus, the valve apparatus according to the disclosure provides a fluid-tight output or connection between a first degassing opening of a cell and an environment.

The valve element can be formed at least partially from a hard component.

The valve element can be connected to the base body, wherein the valve element made from a hard component bounds a gas passageway that is covered by a valve device of the valve element formed from a soft component and connected to the valve element, wherein the valve device is a degassing valve, in particular a burst valve having a membrane.

The valve element can be connected to the base body in a form-fit manner via undercuts and additionally, preferably, in a material-locking manner, wherein this material-locking connection is established in particular by means of a 2-component injection molding process.

In this respect, it can be provided in particular that undercut elements are molded onto the base body, being arranged radially circumferential on the covering side and being approximately equally spaced apart from one another, extending in the axial direction and having a mushroom-like shape, which are then encircled in a form-fit manner in sections by the valve element formed from a hard component in order to connect the valve element to the base body in a form-fit manner.

Also, when producing the valve apparatus or base body and valve element by means of a 2-component injection molding process, a chemical or material-locking connection can be formed between the base body and the valve element during the injection molding process.

In this way, the valve element is securely and reliably connected to the base body.

The connecting-sealing portion can comprise the connecting portion as well as a second and a third sealing portion for sealing on the connecting side and on the covering side against an edge of a second component bounding an opening for receiving the valve apparatus.

By providing the second and the third sealing portions, a safe and reliable sealing of the valve apparatus against a second component is enabled.

The second and the third sealing portions are provided according to the disclosure only for sealing against the second component. However, they can also be provided for fixing the valve apparatus according to a non-preferred embodiment.

A radially circumferential securing recess extending approximately in the axial direction can be formed in a casing wall of the base body, wherein the securing recess is bounded radially outward by a connecting wall, which comprises on its outer side the connecting portion for abutting and connecting to a second component, and wherein the latch portion of the approximately annular securing element likewise extends in the axial direction and, in the final assembly position, is arranged in the securing recess.

By providing a securing element with a corresponding latch portion, a final assembly position of the valve apparatus can be easily and reliably fixed.

The fastening of the valve apparatus according to the disclosure is extremely simple, because the base body formed from a soft component is firstly introduced into an opening of a second component and is thus flexible. Due to the soft component, a correspondingly low force or only a low assembly force is required for this purpose. Then, the latch portion of the securing element is placed in the securing recess in order to fix the valve apparatus in the final assembly position.

Pins extending in the axial direction and pin recesses formed correspondingly on the securing element can be molded onto the valve element, or vice versa, in order to connect the securing element to the valve element in a form-fit manner and to fix it in the final assembly position.

With such a form-fit connection between the locking element and the valve element, only a relatively low assembly force is necessary, and the final assembly position is fixed securely and reliably.

Furthermore, a radially circumferential insertion chamfer can be formed at the free ends of the latch portion extending in the axial direction in order to facilitate insertion of the latch portion into the securing recess.

The second sealing portion of the base body can comprise on the connecting side a second sealing lip that extends radially outward and is radially circumferentially molded onto the base body and is structurally configured so that, in the final assembly position, it is pressed in a sealing manner against an edge of the second component on the connecting side upon being subjected to a pressure prevailing within the first component.

This can in particular be achieved in that a pressurization surface is formed on the second sealing portion, which surface is inclined such that, upon being subjected to a pressure, it exerts a force acting in the direction of a second component onto a sealing region of the second sealing portion lying opposite the pressurization surface in the axial direction.

The third sealing portion of the base body can comprise on the covering side a third sealing lip that extends radially outward and is radially circumferentially molded onto the base body and is structurally configured so that, in the final assembly position, it sealingly abuts the edge of the second component on the covering side with a predetermined force.

In particular, the third sealing lip can extend approximately radially outward, wherein it is simultaneously inclined at a predetermined acute angle in the axial direction in order to exert a pressure acting in the axial direction on a corresponding sealing region of the third sealing portion, such that it is subjected to a force acting in the direction of the second component.

The first sealing portion of the base body can comprise on the connecting side a second sealing lip that extends radially outward and is radially circumferentially molded onto the base body and is structurally configured so that, in the final assembly position, it sealingly abuts the first component on the connecting side with a predetermined force.

This can occur in particular in that the first sealing lip extending radially outwardly is inclined slightly in the axial direction at an acute angle in order to be pressed against a first component with a predetermined force.

The valve apparatus can be rectangular or oval or elliptical or round or polygonal from an aerial perspective.

Furthermore, according to the present disclosure, a battery housing with a valve apparatus as described above is provided. It comprises a housing with a bottom wall a second degassing opening (second component) and a cell having a first degassing opening (first component), wherein the valve apparatus is sealingly connected by a first sealing portion to an edge of the cell bounding the first degassing opening and is sealingly connected by a second and a third sealing portion, as well as by a connecting portion, to an edge of the housing bounding the second degassing opening.

In addition, according to the present disclosure, a method for assembling a valve apparatus according to claim 1 to 8 is provided. It comprises the following steps: inserting a base body on the covering side into a second degassing opening of a second component, introducing a latch portion of a securing element into a securing recess of the base body in order to thereby limit at least a movement of a connecting portion of the base body in a radially inward direction, and in particular to subject the connecting portion to a radially outward acting force such that a final assembly position of the valve apparatus is secured.

According to the disclosure, a valve apparatus, in particular for a battery housing of an electric vehicle according to a sixth exemplary embodiment, is provided. It comprises a base body formed from a hard component, in particular a plastic, wherein the base body delimits a passageway and comprises a covering side and a connecting side, a valve element covering the passageway and connected to the base body, a sealing means formed from a soft component and having a first sealing portion for sealing against a first component and a second sealing portion for sealing against a second component, and a securing element formed from a metal and connected to the base body, having at least one securing arm with a leading edge for engaging with or pressing into a second component in order to secure a final assembly position of the valve apparatus in this manner.

The at least one securing arm of the securing element with the leading edge forms a certain form-fit connection between the valve device and a second component, in particular a battery housing of an electric vehicle. Due to the preferably inclined cutting guide of the securing edge, inclined and radially projecting burrs arise at the interface between the securing edge of the securing arm and a second component opposite an axial direction, which act as barbs. In particular, upon disengagement into a contact surface of a battery housing, these dig in such a way that a disassembly of the valve apparatus is hindered or a release of the valve apparatus is securely and reliably prevented. In addition, the valve apparatus according to the disclosure is extremely simple. Furthermore, the valve apparatus according to the disclosure represents an alternative to valve apparatuses known from the prior art.

Apparatuses known from the prior art are connected to a carrier component usually by means of a screw connection, a snap connection, or a clip connection or a bayonet fastener.

By contrast, the valve apparatus according to the disclosure comprises the securing element, so that the valve apparatus is securely and reliably connected to a second component.

The valve apparatus is in particular free of catching means or connecting means for connecting to one of the two components.

Thus, according to the present disclosure, a valve apparatus is provided that is free of catching means for connecting to a component and therefore requires a very small design space and is in particular extremely flat in construction.

The valve apparatus is preferably provided for a battery-powered vehicle. Battery valves are used in order to transport gas into and out of a battery or cell.

The valve apparatus according to the disclosure is thus configured in particular for degassing a battery or a cell or a battery pack in the event of a thermal runaway and/or for continuous pressure relief or balancing.

Due to the limited space, it is advantageous for the valve apparatus to be of extremely compact design in and around a cell. As already discussed above, conventional fastening solutions are not suitable for this purpose, because they are built up high due to the fastening means used, in particular.

In the valve apparatus according to the disclosure, only the securing element, which is metallic or formed from a metallic material, is provided for this purpose in order to connect the valve apparatus in a space-saving manner to a second component.

Furthermore, in the valve apparatus according to the disclosure, the valve apparatus or its base body is provided so as to sealingly connect both a first component, in particular a degassing opening of a cell, and a second component, in particular a second degassing opening of a battery housing.

Thus, the valve apparatus according to the disclosure provides a fluid-tight output or connection between a first degassing opening of a cell and an environment.

The valve apparatus is preferably free of connecting means, in particular catching means, for connecting to one of the components, apart from the securing element.

This means that the valve apparatus comprises only the securing element formed from a metal with at least one, and preferably a plurality of, catching arms with corresponding leading edges for connecting to a second component, in particular. These leading edges are pressed into or engage with the second component during the assembly process in order to secure the final assembly position of the valve apparatus.

The valve element can be connected to the base body, wherein the valve element comprises a valve device formed from a soft component, which covers the gas passageway, and wherein the valve device is a degassing valve, in particular a burst valve having a membrane.

The securing element can comprise connecting means, via which the securing element can be form-fit and/or frictionally connected to the base body.

The base body can be annular, wherein the securing element connected to the base body can also be annular and comprises a plurality of radially circumferentially arranged, outwardly extending securing arms.

The first sealing portion of the sealing means is preferably configured for axial sealing against a first degassing opening of a first component, and the second sealing portion is configured for radial sealing against a second degassing opening of a second component.

Furthermore, adjacent to the first sealing portion, a third sealing portion can be provided for radially sealing against a first degassing opening of a first component, wherein, adjacent to the second sealing portion, a fourth sealing portion can be provided for axially sealing against a second degassing opening of a second component.

By providing a first and a third sealing portion, an increased sealing effect against a first component is achieved, wherein an increased sealing effect against a second component is correspondingly achieved by providing a second and a fourth sealing portion.

In a casing wall of the base body, a radially circumferential receptacle recess extending approximately in the axial direction can be formed, wherein the receiving recess is bounded radially outwardly by an outer casing wall and radially inwardly by an inner casing wall, and wherein the inner casing wall delimits the passageway, and wherein the securing element comprises a connecting portion arranged in the receptacle opening of the base body, and wherein the connecting portion of the securing element comprises connecting means for frictional and/or form-fit locking connection and is connected thereto to the base body in the region of the receptacle recess.

Such a structural design of the valve apparatus according to the disclosure with the metallic securing element results in an extremely simple and compact design of the valve apparatus according to the disclosure.

The base body and the sealing device are preferably manufactured from two different plastics by means of a 2-component injection molding process and are connected to one another.

Furthermore, the securing arms can be configured to be approximately triangular from an aerial perspective and have one or two or more leading edges for engaging a second component.

In addition, according to the present disclosure, a battery housing with a valve apparatus described above is provided, comprising a housing having a bottom wall and a second degassing opening and a cell having a first degassing opening, wherein the valve apparatus is sealingly connected by a first sealing portion to an edge of the cell that bounds the first degassing opening and by a second sealing portion to an edge of the housing that bounds the second degassing opening, and wherein the valve apparatus engages with a second component via a securing element formed from a metal and being connected to the base body, with at least one securing arm having a leading edge, in such a way that the valve apparatus is connected to the second component.

The advantages of the battery housing according to the disclosure correspond analogously to the advantages described above with respect to the valve apparatus.

In addition, according to the present disclosure, a method for assembling a valve apparatus as described above is provided. It comprises the following steps: inserting a base body on the covering side into a second degassing opening of a second component, engaging a leading edge of at least one securing arm into a second component such that the valve apparatus is connected to the second component so that a final assembly position of the valve apparatus is secured.

The advantages of the method according to the disclosure correspond analogously to the advantages described above with respect to the valve apparatus.

According to a first exemplary embodiment, a valve apparatus, in particular for a battery housing of an electric vehicle according to a fourth exemplary embodiment, is provided. It comprises a base body that delimits a gas passageway and has a covering side and a connecting side, a valve device covering the gas passageway and connectable to the base body, wherein the valve apparatus comprises a first connecting portion for connecting to a first component and a second connecting portion for connecting to a second component, and means formed from a soft component for sealing the first connecting portion against a first component and for sealing the second connecting portion against a second component, wherein the valve apparatus is in particular free of catching means for connection to one of the components.

Valve apparatuses known from the prior art are connected to a carrier component usually by means of a screw connection, a snap device, or a clip connection or a bayonet fastener.

By contrast, the valve apparatus according to the disclosure preferably comprises the soft component or means for sealingly connecting to the first and second components, respectively.

In this way, a valve apparatus is provided that is free of catching means for connecting to a component and therefore requires a very small design space and is in particular extremely flat in construction.

The valve apparatus is preferably provided for a battery-powered vehicle. Such battery valves are used in order to transport gas into and out of a battery or cell.

The valve apparatus according to the disclosure is thus configured in particular for degassing a battery or a cell or a battery pack in the event of a thermal runaway and/or for continuous pressure relief or balancing.

Due to the limited space, it is advantageous for the valve apparatus to be of extremely compact design in and around a cell. As already discussed above, conventional fastening solutions are not suitable for this purpose, because they are built up high due to, for example, a corresponding catching device, in particular.

In the valve apparatus according to the disclosure, only the soft component or the means for sealing connection is provided for this purpose in order to connect the valve apparatus to a first and a second component in a space-saving manner.

In particular, it can be provided that a hard component has a higher melting temperature than the soft component, so that the hard component is not deformed or damaged by activation of the soft component, in particular thermal activation.

Furthermore, in the valve apparatus according to the disclosure, the valve apparatus or its base body is provided for the first time so as to connect both a first component, in particular a first degassing opening of a cell, and a second component, in particular a second degassing opening of a battery housing.

Thus, the valve apparatus according to the disclosure provides a fluid-tight output or connection between a first degassing opening of a cell and an environment.

The base body can comprise a circumferential casing wall that bounds the gas passageway, wherein the valve device is inserted into and connectable to the base body, wherein the valve device is a degassing valve, in particular a burst valve, with a membrane.

The valve device is thus preferably a pressure compensation valve or burst valve (or membrane valve), wherein the membrane is only connected to a covering side of the valve device, or wherein the membrane is connected by overmolding to a hard component forming the valve device.

Alternatively, the valve device can also be a poppet valve (mushroom valve) having a sealing plate, wherein the valve device then comprises struts arranged in the gas passageway for receiving the sealing plate.

The base body can be formed approximately in a C-shape in cross-section and comprises a radially circumferential first flange portion in the region of the covering side, wherein the base body comprises a radially circumferential second flange portion in the region of the connecting side, and wherein the first and the second flange portions are connected to one another via the casing wall, and wherein the base body is configured so as to be foldable, and two halves of the base body are connected to one another via a hinge, in particular a film hinge or an articulated hinge, and wherein the second flange portion can comprise insertion recesses.

Due to the fact that that base body is foldable and that insertion recesses are provided in the second flange portion or that the second flange portion is only formed in sections, it can be easily inserted and arranged in a final assembly position in a degassing opening of a first component and in a degassing opening of a second component.

The base body can be rectangular or oval or elliptical or round or polygonal in configuration.

The first connecting portion can preferably be arranged on the covering side on the valve device and/or on the covering side on the first flange portion, wherein the second connecting portion can preferably be arranged on the outside of the casing wall of the base body and/or on the covering side on the flange-like connecting portion and/or connecting sides on the first flange portion.

The valve apparatus according to the disclosure can thus be connected to the first and the second component via a first connecting portion, a second connecting portion, and a third connecting portion, which can also be the second connecting portion. What is important here is that the base body comprises at least a first connecting portion for sealing against the first component and the valve device comprises a further connecting portion for sealing against the passageway of the base body and the base body or the valve device comprises the second or third connecting portion for sealing against the first component.

The valve device can comprise a frame or a valve frame, wherein the frame can comprise catching elements arranged for connecting to the catching recesses arranged on the base body and configured correspondingly, wherein, in particular, a plurality of catching recesses arranged one above the other can be provided between the covering side and the connecting side in order to form a plurality of catching steps so as to allow for a tolerance compensation between the first and the second component.

Due to the fact that a plurality of catching recesses arranged one above the other, in particular three or four or five catching recesses, can be provided between the covering side and the connecting side, the valve apparatus according to the disclosure is also suitable for first and second components that have different distances from one another, so that the same valve apparatus according to the disclosure can always be used. This is enabled by the fact that the plurality of catching recesses are provided, and tolerance compensation is thus possible.

The base body and the connecting device can each be formed from a hard and a soft component and preferably produced by a 2-component injection molding process.

At least one stiffening strut or a plurality of stiffening struts can be configured in the context of the valve device.

In this way, the stability or stiffness of the valve device is increased, and support of the membrane or a support surface for the membrane is also provided.

The membrane can preferably be connected to the frame of the valve device on the covering side.

The hard component can be formed from PPT or PPA, preferably with fiberglass, and the means for sealing connection and the soft component can be a hot melt adhesive material made from TPE or TPS and can each be formed with a heat-activatable adhesive or EVA, wherein the soft component has a lower melting temperature than the hard component, or the means for sealing connection and the soft component are formed from an adhesive material, or the means for sealing connection and the soft component are formed from a foam material, the means for sealing connection and the soft component can be formed from an elastic plastic material.

The means for sealing connection can be activatable by means of heat, for example by means of a laser or by means of ultrasonics or by means of induction.

Furthermore, according to the present disclosure, a battery housing with a valve apparatus as described above is provided. It comprises a housing having a bottom wall and a second degassing opening and a cell having a first degassing opening, wherein the valve apparatus is sealingly connected by a first connecting portion to an edge of the cell that bounds the first degassing opening and by a second connecting portion to an edge of the housing that bounds the second degassing opening, and preferably, by a third connecting portion, a valve device of the valve apparatus is connected to a base body of the valve apparatus.

Furthermore, according to the present disclosure, a method for assembling a valve apparatus as described above is provided. It comprises the following steps: placing a folded base body on a covering side of a second degassing opening of a second component, subjecting the base body to a compressive force acting in the direction of the connecting side, and thereby unfolding and introducing a base body into a first degassing opening of a first component and into the second degassing opening of the second component, inserting the valve device into a gas passageway of the base body, and locking the valve device to the base body.

The disclosure according to the fourth exemplary embodiment thus comprises two 2-component plastic parts, namely an outer frame or the base body with a film hinge and the valve device, which is inserted separately into the frame.

The assembly of the disclosure is carried out as follows. First, the folded frame is placed on an opening. The frame is then erected or unfolded by pushing down and pre-fixed or fixed by a first and a second flange portion.

An outward-facing seal seals the frame against the wall of the opening in a radial direction. Then, the valve is inserted axially into the frame. It is held in position by a latched locking mechanism. The locking mechanism has several catching steps, so that the valve can be fixed on a plurality of planes in order to compensate for tolerances between the two components. The valve is sealed against the frame in the radial direction and against a sheet metal below the main plate opening in axial direction.

Furthermore, according to the present disclosure, a valve apparatus according to a first exemplary embodiment, in particular for a battery housing of an electric vehicle, is provided. It comprises a base body, preferably a valve housing for a valve device, made from a hard component that bounds a gas passageway and has a covering side and a connecting side, a valve device covering the gas passageway and connected to the base body, wherein the base body comprises a first connecting portion for connecting to a first component, in particular a degassing opening of a cell or a battery or an accumulator, and a second connecting portion for connecting to a second component, in particular a battery housing, and means formed from a soft component for sealingly connecting the first connecting portion to a first component and for sealingly connecting the second connecting portion to a second component, and wherein the valve apparatus is in particular free of locking means for connecting to one of the components.

Valve apparatuses known from the prior art are connected to a carrier component usually by means of a screw connection, a snap device, or a clip connection or a bayonet fastener.

By contrast, the valve apparatus according to the disclosure preferably comprises the soft component or means for sealingly connecting to the first and second components, respectively.

In this way, a valve apparatus is provided that is free of catching means for connecting to a component and therefore requires a very small design space and is in particular extremely flat in construction.

The valve apparatus is preferably provided for a battery-powered vehicle. Such battery valves are used in order to transport gas into and out of a battery or cell.

The valve apparatus according to the disclosure is thus configured in particular for degassing a battery or a cell or a battery pack in the event of a thermal runaway and/or for continuous pressure relief or balancing.

Due to the limited space, it is advantageous for the valve apparatus to be of extremely compact design in and around a cell. As already discussed above, conventional fastening solutions are not suitable for this purpose, because they are built up high due to, for example, a corresponding catching device, in particular.

In the valve apparatus according to the disclosure, only the soft component or the means for sealing connection is provided for this purpose in order to connect the valve apparatus to a first and a second component in a space-saving manner.

In particular, it can be provided that a hard component has a higher melting temperature than the soft component, so that the hard component is not deformed or damaged by activation of the soft component, in particular thermal activation.

Furthermore, in the valve apparatus according to the disclosure, the valve apparatus or its base body is provided for the first time so as to connect both a first component, in particular a first degassing opening of a cell, and a second component, in particular a second degassing opening of a battery housing.

Thus, the valve apparatus according to the disclosure provides a fluid-tight output or connection between a first degassing opening of a cell and an environment.

The base body can comprise a circumferential casing wall that bounds the gas passageway, wherein a circumferential edge with a surface facing towards the front face is formed in the gas passageway, on which the valve device is arranged, wherein the valve device comprises a degassing valve, in particular a burst valve having a membrane, which is preferably connected to the base body by means of ultrasonic welding.

The valve device is thus preferably a pressure compensation valve or burst valve (or membrane valve), wherein the membrane is only connected to a covering side, or wherein the membrane is connected to the base body by overmolding with the hard component forming the base body or a further soft component surrounding the base body at least in regions.

Alternatively, the valve device can also be a poppet valve (mushroom valve) having a sealing plate, wherein the base body comprises struts arranged in the gas passageway for receiving the sealing plate.

The base body can have a radially circumferential flange portion in the region of the covering side with a surface facing towards the connecting side, wherein this surface forms the second connecting portion and wherein the base body can have a front face in the region of the connecting side forming the first connecting portion.

The two connecting portions enable a secure and reliable sealing connection of the valve apparatus to a first component and a second component.

The base body can be oval or elliptical or round or polygonal or rectangular, with semi-circular end portions.

Furthermore, the base body can also be configured in two parts in order to allow for tolerance equilibrium between a first component and a second component, wherein a first part of the base body comprises the first connecting portion for sealing abutment on a first component, and wherein a second part of the base body comprises the second connecting portion for sealing abutment on a second component, wherein, in a connecting region between the first and the second part, undercuts, correspondingly configured groove/spring elements, or the like can preferably be formed, and wherein the means for sealing connection are also arranged in the connecting region in order to interconnect the first part and the second part of the base body.

In particular, due to the two-part configuration of the base body, a tolerance compensation in a direction of degassing can be enabled between the first component or the first connecting portion of the valve apparatus and a second component or the second connecting portion of the valve apparatus.

In this way, the valve apparatus can easily be connected in a sealing manner with a first and a second component despite possible manufacturing and assembly tolerances.

In addition, the base body on the outer side of the casing wall can comprise a third connecting portion for sealingly connecting to an inner casing wall of a second component, wherein the third connecting portion can be arranged orthogonally to the first and the second connecting portion.

By providing a third connecting portion, it is possible to connect the valve apparatus in particular to the second component in an even more secure and reliable sealing manner.

In the base body, a channel structure for introducing the means for sealing connection can be configured in the region of the flange portion and/or the casing wall, wherein the channel structure opens into the first and/or the second and/or the third connecting portion.

The hard component can be formed from PPT or PPA, preferably with glass fibers, and the means for sealing connection or the soft component can be formed from a hot melt adhesive material of TPE or TPS, and a heat-activatable adhesive or EVA, respectively, wherein the soft component can have a lower melting temperature than the hard component.

Furthermore, the means for sealing connection or the soft component can be formed from an adhesive material.

Additionally, the means for sealing connection and the soft component can alternatively be formed from a foam material.

The means for sealing connection can be activatable by means of heat, for example a laser or by means of induction or by means of ultrasonics (e.g., ultrasonic welding).

Furthermore, according to the present disclosure, a battery housing with a valve apparatus as described above is provided.

This battery housing comprises a housing having a bottom wall and a second degassing opening and a cell having a first degassing opening, wherein the valve apparatus is sealingly connected by a first connecting portion to an edge of the cell that bounds the first degassing opening and by a second connecting portion to an edge of the housing that bounds the second degassing opening, and preferably by a third connecting portion to an inner casing wall of the second degassing opening of the housing.

The advantages described above using the valve apparatus correspond analogously to the advantages of the battery housing according to the disclosure.

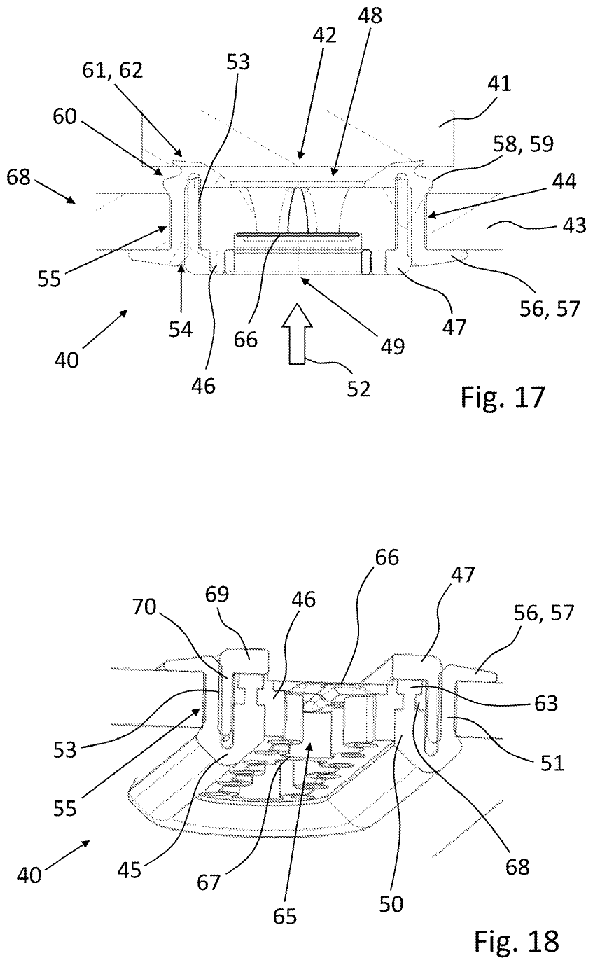

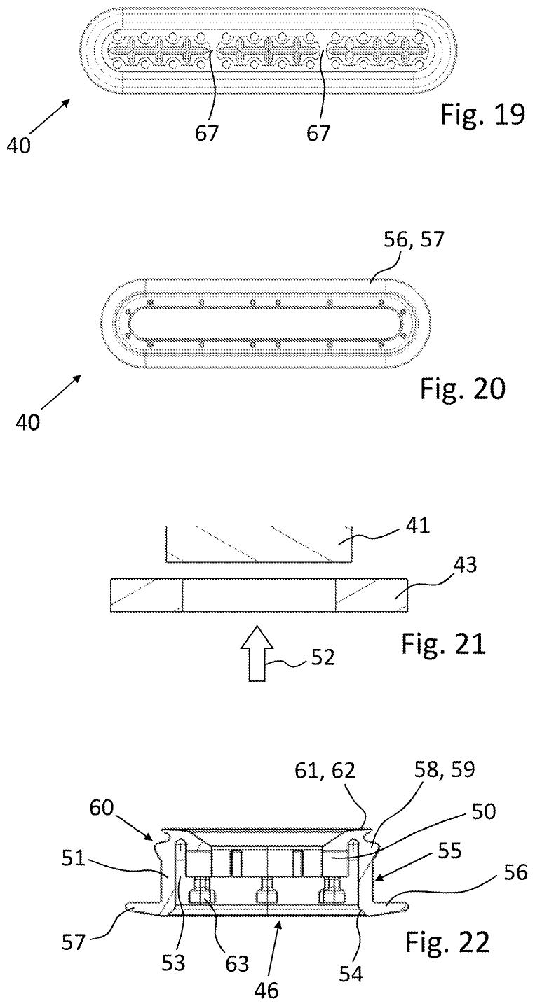

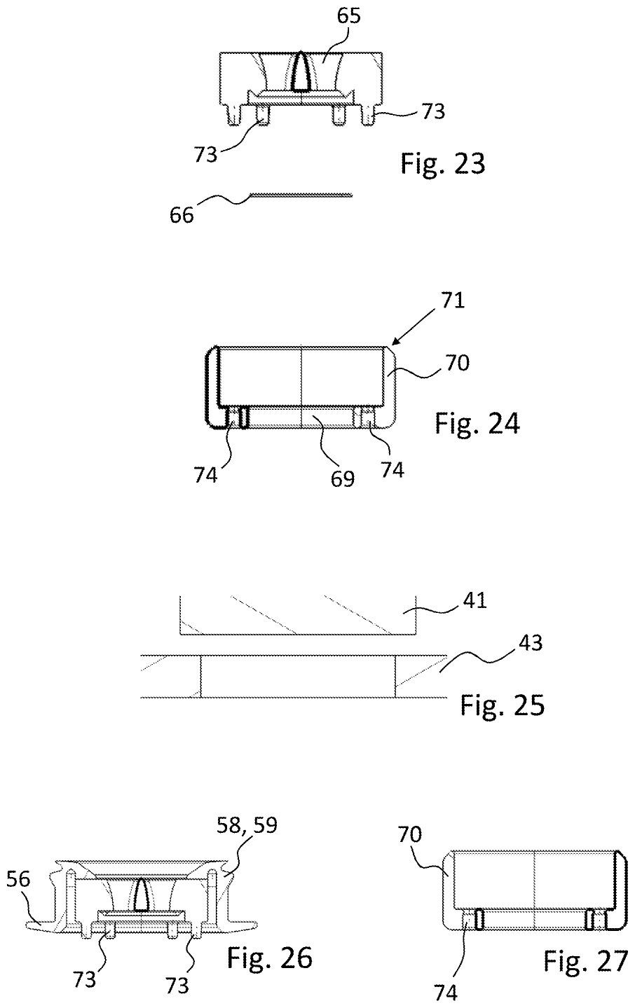

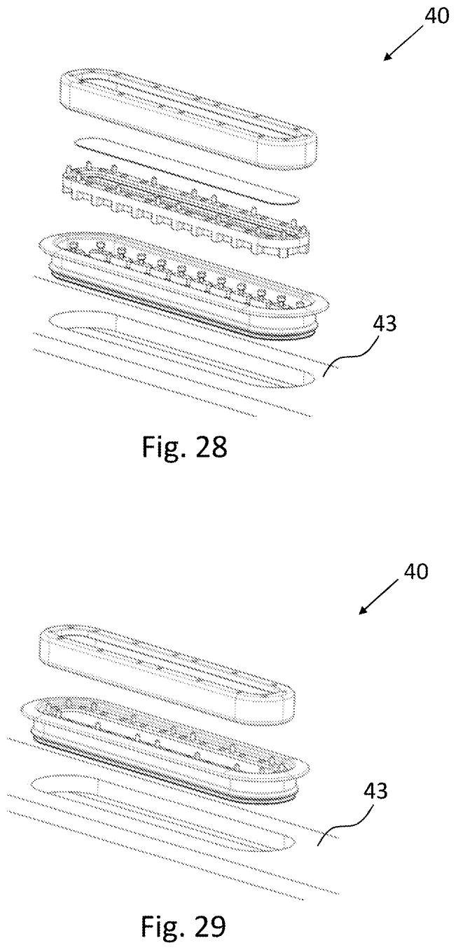

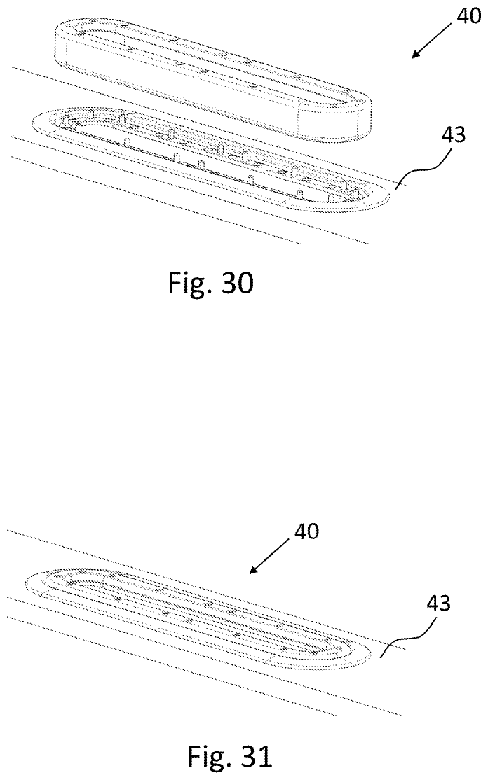

In the following, a valve apparatus 40 according to the disclosure is initially described in further detail according to a fifth exemplary embodiment (FIGS. 17 to 31).

The valve apparatus 40 is configured in particular for a battery housing of an electric vehicle and is sealingly connectable to a first component 41, in particular a first degassing opening 42 of a cell or a battery, and a second component 43, in particular a second degassing opening 44 of a housing or a battery housing.

The valve apparatus 40 comprises a base body 45, a valve element 46, and a securing element 47.

The base body 45 comprises a connecting side 48 facing towards a battery housing and a covering side 49 opposite the connecting side.

Furthermore, the base body 45 is formed from a soft component in an approximately annular shape.

The base body 45 comprises an inner casing wall 50 and an outer casing wall 51 interconnected on the connecting side.

A recess extending in the axial direction 52 between the inner casing wall 50 and the outer casing wall 51 forms a securing recess 53. On the covering side, the securing recess 53 can comprise a first insertion slope 54 in the region of the outer casing wall 51.

A radially outwardly facing side of the outer casing wall 51 forms a connecting portion 55. Therefore, the outer casing wall 51 is also referred to as the connecting wall.

A third sealing portion 56 with a third sealing lip 57 extending outwardly in the radial direction is formed on the covering side of the outer casing wall 51. Although the third sealing lip 57 extends radially outward, it is slightly inclined at an acute angle relative to the axial direction 52 in order to produce a corresponding sealing contact pressure relative to the second component 43.

Furthermore, a second sealing portion 58 is molded onto the outer casing wall 51 on the connecting side, with a radially circumferential second sealing lip 59 which also extends radially outwards. The second sealing lip 59 extends radially outward, wherein it is also inclined at an acute angle relative to the axial direction 52 in the direction of the third sealing lip 57 and the second component 43, respectively, in order to produce a corresponding contact pressure on the second component 43.

In particular, the second sealing lip 59 comprises on the connecting side a pressurization portion 60 inclined relative to the axial direction 52 so that the second sealing lip 59 is subject to an external force via the pressurization portion 60 in the event of a pressure arising inside the second component 43, such that a sealing region of the second sealing lip 59 is accordingly subjected to this force towards the second component 43, and the sealing is against a connection-side surface of the second component 43 is increased.

In the connecting region between the inner casing wall 50 and the outer casing wall 51, a first sealing portion 61 is molded onto a first sealing lip 62 extending in the radial direction outwardly for sealing abutment with the first component 41. The first sealing lip 62 is inclined orthogonally to the axial direction 52 slightly in the axial direction 52 so as to produce a corresponding contact pressure on a first component 41.

An edge that bounds the opening of the second component 43 can have different edge thicknesses due to the structural configuration of the second and the third sealing lips 59, 57 and still be securely and reliably sealingly connected to the valve apparatus 40 according to the disclosure.

In the present exemplary embodiment, sheet thicknesses of between 3 mm and 4.5 mm, in particular between 3.5 mm and 3.8 mm, are provided.

Undercut elements 63 are molded onto the inner casing wall 50, being arranged radially circumferential on the covering side and being approximately equally spaced apart from one another, extending in the axial direction 52 and having a mushroom-like shape. The undercut elements 63 are provided in order to connect the base body 45 in this region to the valve element 46.

The radially circumferentially arranged first sealing lip 62, and in particular an inner portion of the inner casing wall 50 of the base body 45, bound a passageway 64. In this passageway 64, the valve element 46 is arranged.

The valve element 46 is approximately annular in shape and bounds a valve passageway 65. The valve passageway 65 is covered by a valve device 66 of the valve element 46.

Furthermore, the valve element 46 is formed from a hard component.

The valve device 66 forms a degassing valve, in particular a burst valve having a membrane. That is to say, in the present embodiment, the valve device 66 is a membrane formed from a soft component and connected to the valve element 46.

The valve passageway 65 comprises stiffening struts 67 that extend to opposite sides of the valve element 46 through the valve passageway 65.

The valve element 46 is connected in a form-fit manner on the covering side to the inner casing wall 50 in the region of the undercut elements 63. Thus, in this region, the valve element 46 comprises undercut receptacles 68 configured so as to correspond to the undercut elements 63.

In addition to this form-fit connection, the valve element 46 is preferably connected in a material-locking manner, in particular chemically, to the base body 45 by means of a 2-component injection molding process.

The securing element 47 is formed from a hard component and is also structurally designed so as to approximately annularly correspond to the securing recess 53.

Furthermore, the securing element 47 comprises an annular, disk-shaped covering portion 69, on which a radially circumferentially extending latch portion 70 is molded in the axial direction 52.

The latch portion 66 comprises a second insertion chamfer 71 on the connecting side for insertion into the securing recess 53.

A wall thickness of the latch portion 70 corresponds approximately to a width of the securing recess 53 or is preferably slightly wider than a width of the securing recess 53. In this way, the latch portion 70 of the securing element 47 not only limits a movement of the connecting portion 55 or the outer casing wall 51 in the radial direction inwardly, but additionally subjects it to a retaining force acting in the radial direction outwardly.

In this way, in a final assembly position 68, the valve apparatus 40 can be securely and reliably arranged in and connected to an opening 44 of the second component 43.

Furthermore, pins 73 are molded onto the valve element 46 on the covering side, being approximately equally spaced apart from one another and extending in the axial direction 52.

In the covering portion 65 of the securing element 47, pin recesses 74, which are configured so as to correspond to the pins 73, are formed.

The pins 73 can be received in a form-fit manner in the pin recesses 74 in order to secure the securing element 47 in the final assembly position 72 and also to connect to the valve element 46.

Furthermore, according to the present disclosure, a battery housing (not shown) having a valve apparatus 40 as described above is provided, wherein the battery housing comprises a housing 43 with a second degassing opening 44 and a cell 41 having a first degassing opening 42, wherein the valve apparatus 40 is sealingly connected by a first sealing portion 61 to an edge of the cell 41 bounding the first degassing opening 42 and is sealingly connected by a second and a third sealing portion 58, 56, as well as by a connecting portion 55, to an edge of the housing 43 bounding the second degassing opening 44.

In addition, according to the present disclosure, there is provided a method for assembling a valve apparatus 40 as described above. It comprises the following steps: inserting a base body 45 into a second degassing opening 44 of a second component 43, introducing a latch portion 70 of a securing element 47 into a securing recess 53 of the base body 45 in order to thereby limit at least a movement of a connecting portion 55 of the base body 45 in a radially inward direction, and in particular to subject the connecting portion 55 to a radially outward acting force such that a final assembly position 72 of the valve apparatus 40 is secured.

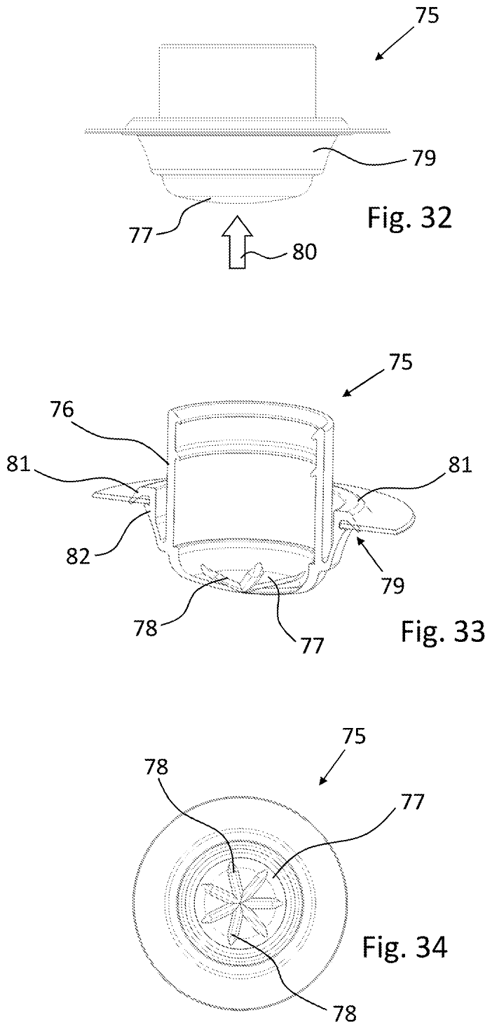

In the following, a further exemplary embodiment of a valve apparatus 75 is described in further detail (FIGS. 32 and 34).

This valve apparatus 75 is formed as a single-part component from a soft component.

The valve apparatus 75 is approximately cup-shaped. Accordingly, the valve apparatus 75 comprises a radially circumferential casing wall 76 and a front wall.

The front wall is configured as a burst element 77 and comprises recesses 78 arranged in a star pattern that form the target breaking points and thus a bursting or rupturing of the valve apparatus 40.

According to this exemplary embodiment, a radially circumferential collar 79 is formed on the covering side of the valve apparatus 75 in the region of the bursting element 77. The collar 79 is configured so as to radially flare in an axial direction 80.

At the free end of the collar 79, a first radially circumferential sealing lip 81 and a second sealing lip 82 extending towards the first sealing lip 81 are formed.

In the region between the first and the second sealing lips 81, 82, an opening of a wall bounding a component is sealingly receivable.

This valve apparatus 75 can be connected to a component according to any one of the exemplary embodiments described herein. Preferably, however, according to this exemplary embodiment, it is also provided that the valve apparatus 75 is free of catching means and/or fastening means for connecting to a component, and is connected in particular via the first sealing lip 81 and the second sealing lip 82, or via a connecting wall 83 extending in the axial direction 80 radially circumferentially between the two lips.

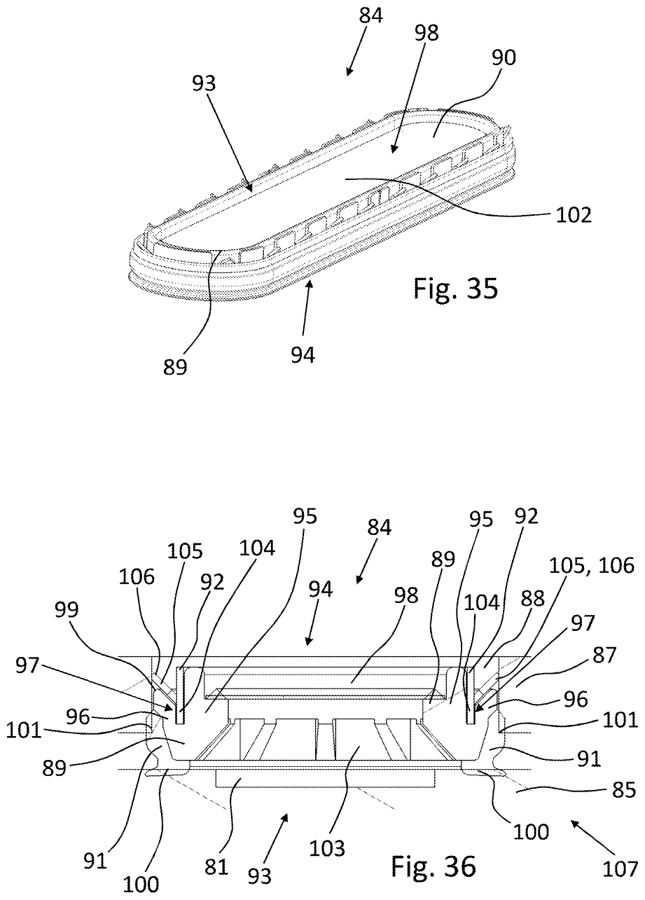

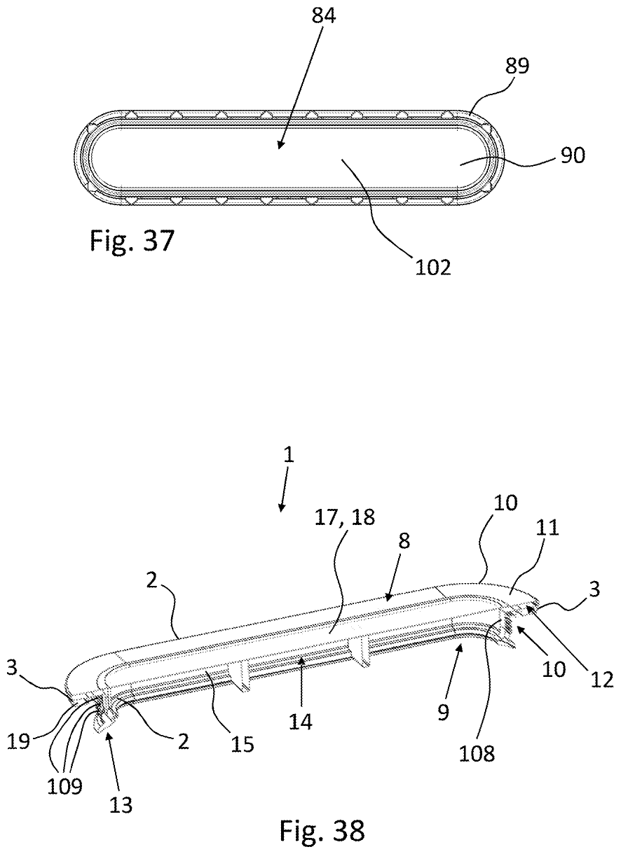

In the following, a valve apparatus 84 according to the disclosure is described in further detail according to a seventh exemplary embodiment (FIGS. 35 and 37).

The valve apparatus 84 is configured in particular for a battery housing of an electric vehicle and is sealingly connectable to a first component 85, in particular a first degassing opening 86 of a cell or a battery, and a second component 87, in particular a second degassing opening 88 of a housing or a battery housing.

The valve apparatus 84 comprises a base body 89, a valve element 90, a sealing device 91, and a securing element 92.

The base body 89 comprises a connecting side 93 facing towards a battery housing and a covering side 94 opposite the connecting side.

The base body 89 comprises an inner casing wall 95 and an outer casing wall 96 that bound an axially extending and radially circumferentially configured connecting recess 97.

Furthermore, the inner casing wall bounds a passageway 98.

On the covering side, the connecting recess 97 can comprise a first insertion slope 99 in the region of the outer casing wall 96.

On the connecting side, the sealing device 91 is molded onto a front face of the base body 89 as well as onto the connecting side in the region of the outer casing wall 96.

The sealing device 91 is annular in configuration, as is the base body. The base body 89 and the sealing device 91 are manufactured from two different plastics by means of a 2-component injection molding process and are connected to one another in a material-locking fashion.

Additionally and/or alternatively, a form-fit and/or friction-fit connection in the form of undercuts and/or recesses and correspondingly configured undercut elements can also be provided.

On the connecting side and front side, the sealing means 91 forms a first sealing portion 100 for sealing abutment on the first component 85 and radially circumferentially a second sealing portion 101 for sealing against the second component 87.

The base body 89 is formed from a hard component, and the sealing means 91 is formed from a soft component.

The passageway 98 is covered by a valve element 90, wherein the valve element 90 comprises a valve device or membrane 102 connected to the base body 89 such that the valve element 90 is configured as a burst valve.

Stiffening struts 103 can be provided in the region of the passageway 98.

In addition, the valve apparatus 84 comprises the securing element 92.

The securing element 92 comprises an axially extending connecting portion 104 that is received and retained in the connecting recess 97 of the base body.

To retain the connecting portion 104 of the securing element 92 in the connecting recess 97 of the base body, form-fit and/or friction-fit connecting means (not shown), such as corresponding protrusions and/or recesses or catching elements or contours, can be provided for engaging the securing element 92 with the base body 89.

Furthermore, securing arms 105 arranged radially circumferentially and in particular approximately equally spaced from one another are molded onto the securing element.

The securing arms 105 are configured approximately triangularly from an aerial perspective, wherein the tip of the triangle and/or the two free legs form a sharp-edged securing edge or a plurality of sharp-edged securing edges 106.

The securing edge 106 is suitable for penetration or engaging with the second element 87 in order to secure the valve apparatus in a final assembly position 107.

In addition, according to the present disclosure, a battery housing with a valve apparatus described above is provided, comprising a housing having a bottom wall and a second degassing opening and a cell having a first degassing opening, wherein the valve apparatus is sealingly connected by a first sealing portion to an edge of the cell that bounds the first degassing opening and by a second sealing portion to an edge of the housing that bounds the second degassing opening, and wherein the valve apparatus engages with a second component via a securing element formed from a metal and being connected to the base body, with at least one securing arm having a leading edge, in such a way that the valve apparatus is connected to the second component.

In addition, according to the present disclosure, a method for assembling a valve apparatus as described above is provided. It comprises the following steps: inserting a base body on the covering side into a second degassing opening of a second component, engaging a leading edge of at least one securing arm into a second component such that the valve apparatus is connected to the second component so that a final assembly position of the valve apparatus is secured.

Insofar as technically possible, the valve apparatus 84 according to the disclosure can be combined as desired with the technical features of the further exemplary embodiments according to the sixth exemplary embodiment.

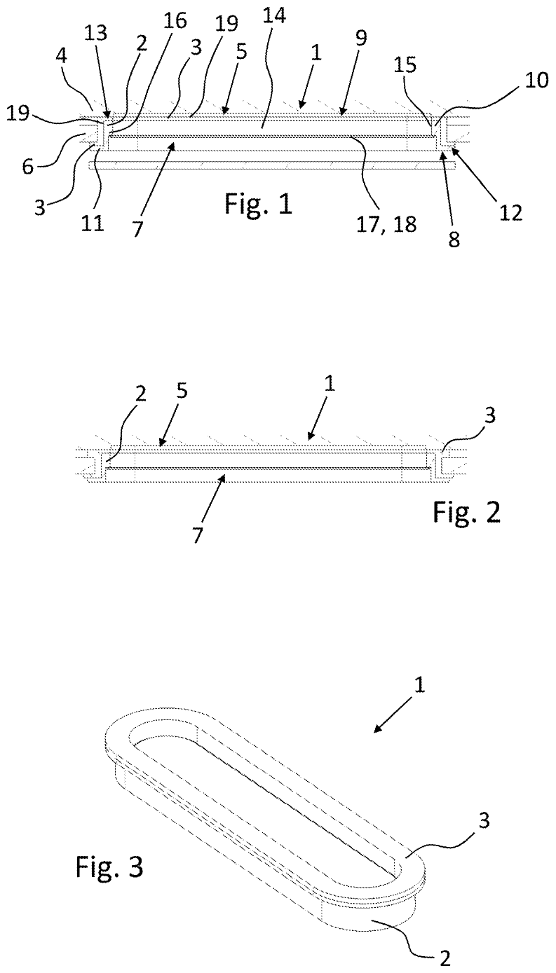

According to a first exemplary embodiment, a valve apparatus 1 according to the disclosure, in particular for a battery housing of an electric vehicle, comprises a base body 2 and means 3 for sealingly connecting to a first component 4, in particular a first degassing opening 5 of a cell or a battery, and a second component 6, in particular a second degassing opening 7 of a housing or a battery housing (FIGS. 1-3).

The valve apparatus 1 comprises a covering side 8 and a connecting side 9.

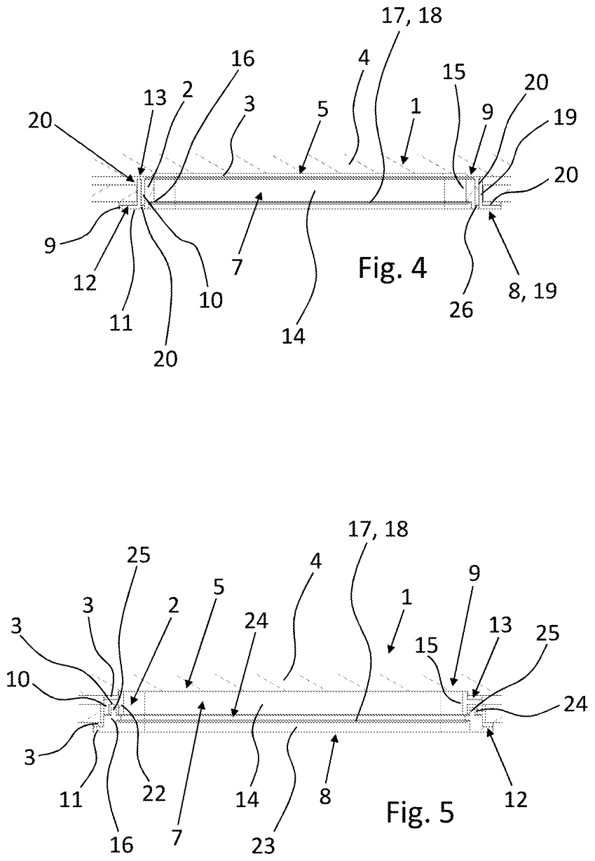

The base body 2 is oval or rectangular in shape from an aerial perspective, with semi-circular end sections lying opposite one another (FIG. 3). Alternatively, the valve apparatus or the base body 2 can be circular or have another suitable shape.

In addition, the base body comprises a casing wall 10. A radially circumferential flange portion 11 is molded onto the casing wall 10 in the region of the covering side 8.

An annular disk-shaped surface of the flange portion 11 facing towards the connecting side 9 forms a second connecting portion 12.

An annular disk-shaped front face of the casing wall 10 of the base body 2 facing towards the connecting side 9 forms a first connecting portion 13.

Furthermore, the base body 2 or the casing wall 10 bounds a gas passageway 14.

In the region of the gas passageways 14 or an inner casing wall 15 of the base body 10, an edge 16 is formed in a radially circumferential manner.

At the edge 16, An valve device 17 with a membrane 18 is preferably molded onto or sealingly connected to the edge 16.

In addition, the valve apparatus comprises a soft component or means for a sealing connection 19.

According to this exemplary embodiment, the means 3 for sealing connection can be arranged on the first connecting portion 13 for connecting to a first component 4, the second connecting portion 12 for connecting to a second component 6, and also on the outer casing wall 10 for sealing connection to the second component 6.

According to this exemplary embodiment, the means 3 for sealing connection is configured as a thermoplastic elastomer, which is preferably activatable by means of a sonotrode of an ultrasonic device.

Alternatively, activation by means of heat, for example by means of induction or by means of laser, can also be provided.

Instead of a TPE as a means 3 for sealing connection, an adhesive, a two-component adhesive, or a foam or any other means suitable for sealing connection, which is liquid and/or gas-tight and in particular fluid-tight, can also be provided.

The valve apparatus according to the disclosure is thus connectable on the front face in the region of the connecting side 9 radially circumferentially to an edge of the first component 4 that bounds the first degassing opening 5, or is so connected in a final assembly position.

Via the second connecting portion 12, the valve apparatus is connected to an edge of the second component 6 that bounds a second degassing opening 7.

In principle, a connection of the valve apparatus 1 via the means for sealing connection 19 via the first connecting portion 13 and the second connecting portion 12 is sufficient.

Preferably, as also provided in the present exemplary embodiment, the outer casing wall 10 of the base body 2 is also sealingly connected to an inner casing wall 15 of the second component 6, which bounds the second degassing opening 7.

Alternatively, but not preferably, corresponding locking means could also be provided here, so that the means for sealing connection are provided predominantly or exclusively for sealing.

In the following, the valve apparatus 1 according to the disclosure is described based on a second exemplary embodiment (FIG. 4).

Unless otherwise described, the valve apparatus 1 according to the second exemplary embodiment of the disclosure corresponds to the valve apparatus 1 according to the first exemplary embodiment. Identical technical features bear the same reference numerals.

By contrast to the first exemplary embodiment, channel structures 20 extending from the covering side 8 towards the connecting side 9 are formed in the base body 2.

The channel structures 20 extend at least from the covering side 8 of the flange portion 11 towards the first connecting portion 13 and towards the second connecting portion 12 and open into the latter.

Preferably, and not shown, the channel structures 20 also open into the outer casing wall 10 of the base body 2.

According to this exemplary embodiment, all of the above means for sealing connection 19 can be provided. However, according to the second exemplary embodiment, a foam is preferably provided, which can be inserted or arranged via the channel structures 20 in the region of the first connecting portion 13, the second connecting portion 12, and the third connecting portion 21.

A corresponding application apparatus, such as a nozzle or a gun, can be provided for the application of the foam.

In the following, a valve apparatus 1 according to the disclosure is described in further detail according to a third exemplary embodiment (FIG. 5).

Unless otherwise described, the valve apparatus 1 according to the third exemplary embodiment of the disclosure has the same technical features as the valve apparatus 1 according to the first exemplary embodiment. Identical technical features bear the same reference numerals.

By contrast to the first and second exemplary embodiments, the base body 2 is formed from a first part 22 and a second part 23 according to the third exemplary embodiment.

The first part 22 and the second part 23 can be connected to one another via a separate connecting means, and preferably via the means 3 for sealing connection.

A groove/spring connection 25 is arranged in a corresponding connecting region 24 between the first part 22 and the second part 23.

The connecting region 24 of the valve apparatus 1 according to the third exemplary embodiment enables a tolerance compensation to compensate for manufacturing and/or assembly tolerances between the first component 4 and the second component 6.

All of the above-described means can be provided as the means 3 for sealingly connecting the valve apparatus 1 to the first component 4 and the second component 6.

However, it is preferably provided that a TPE, which can be activated by means of a sonotrode of an ultrasonic device, is provided as the means 3 for sealing connection.

In the following, a valve apparatus 1 according to the disclosure is described in further detail according to an eighth exemplary embodiment, which shows a further configuration of the first three exemplary embodiments (FIG. 38).

Unless otherwise described, the valve apparatus 1 according to this exemplary embodiment has the same technical features as the valve apparatuses 1 according to the first, second, and third exemplary embodiments. Identical technical features bear the same reference numerals.

According to this embodiment, the valve apparatus comprises a soft component or a means for sealing connection 19.

According to this exemplary embodiment, the means 3 for sealing connection are provided and configured only on the second connecting portion 12 for connection to a portion of the second component 6 arranged parallel thereto. The sealing connection 3 is configured according to the above exemplary embodiments.

A sealing element 108 formed from a soft component, in particular made from rubber, is arranged on the outer casing wall 10 of the base body 2. The sealing element 108 comprises, in the region of the casing wall 10, a plurality, in particular at least one or two or three or four, tangentially circumferential and radially extending sealing lips 109. The sealing lips 109 are provided for sealing against an inner casing wall of the edge of the component 6, which bounds the second degassing opening 7. The radial sealing lips 109 can be configured so as to only seal against the inner casing wall of the second degassing opening 7. It can also be provided that the radial sealing lips 109 are also configured so as to hold the valve apparatus 1 by means of surface pressure opposite the inner casing wall of the second degassing opening 7.

At a free end facing in the direction of the connecting side 9, the sealing element 108 comprises an axial sealing lip 110 for sealing against the first component 4. According to a further development, this axial sealing lip 110 can form a radially circumferential catching edge (not shown) for rearwardly engaging an edge of the first component 4 that bounds the first degassing opening 5. The edge of the first component 4 can have a correspondingly configured counter-catching edge (not shown) for this purpose.

The valve apparatus according to the disclosure is thus connectable, or connected, on the front face in the region of the connecting side 9 via the axial sealing lip 110 in a sealing manner against an edge of the first component 4 that bounds the first degassing opening 5, or is so connected in a final assembly position.

Via the second connecting portion 12, the valve apparatus is sealingly connected to an edge of the second component 6 that bounds a second degassing opening 7.

Furthermore, according to the disclosure, a battery housing or a second component 6 is provided with the valve apparatus 1 according to the disclosure.

This battery housing 6 comprises a housing having a bottom wall and a second degassing opening 7 and a cell 4 having a first degassing opening 5, wherein the valve apparatus 1 is sealingly connected by a first connecting portion 13 to an edge of the cell 4 that bounds the first degassing opening 5 and by a second connecting portion 12 to an edge of the housing 6 that bounds the second degassing opening 7, and preferably by a third connecting portion 21 to an inner casing wall of the second degassing opening 7 of the housing 6.

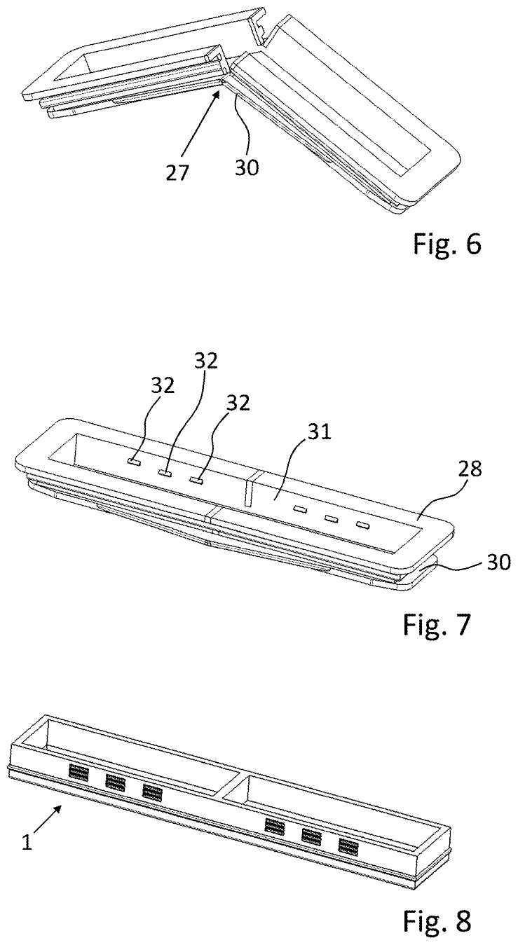

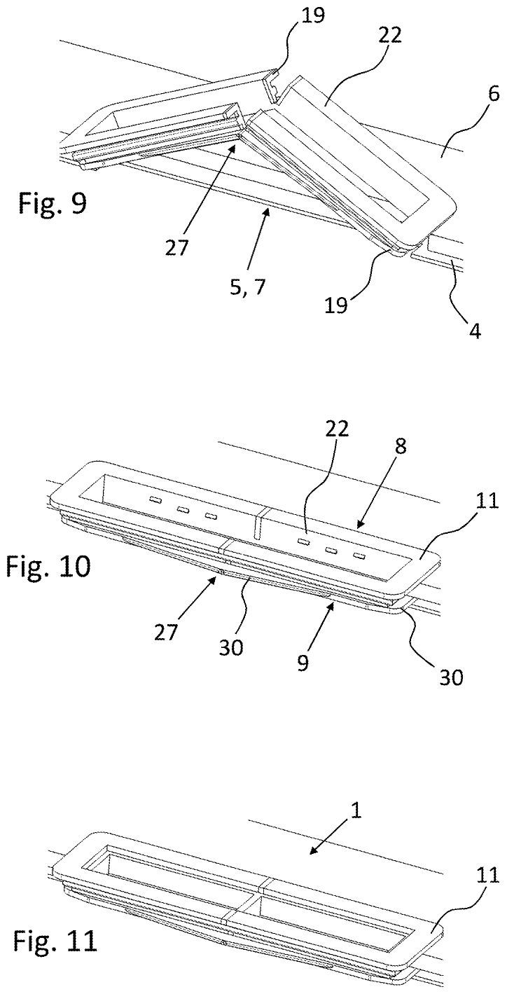

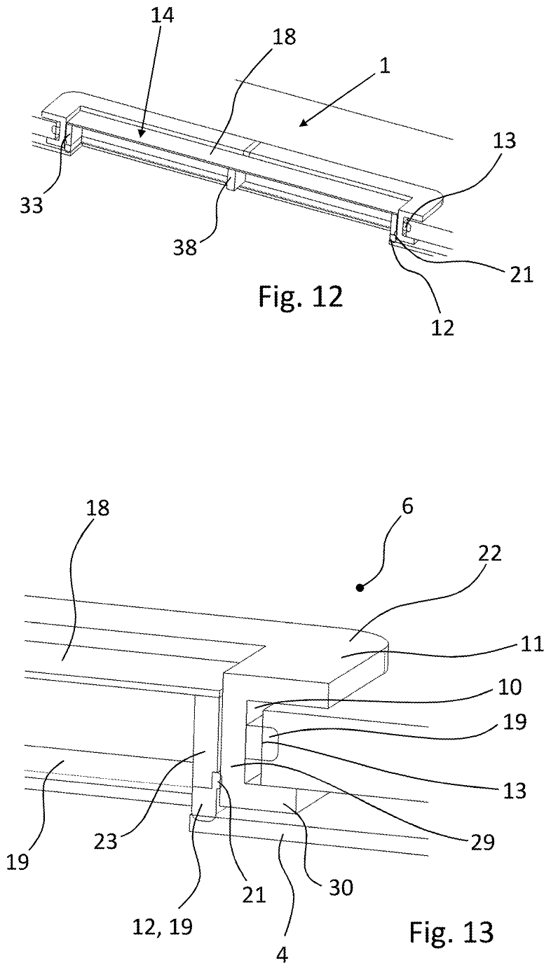

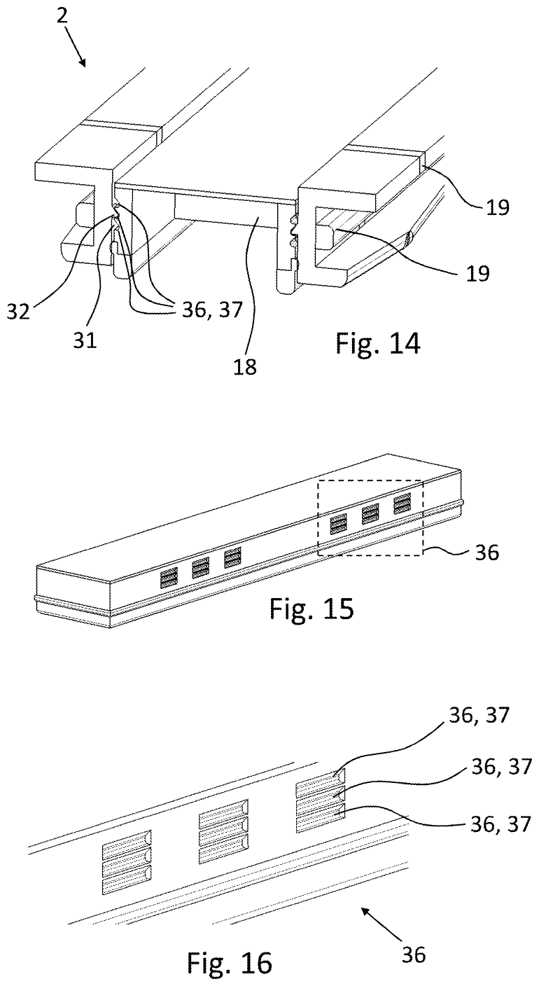

In the following, the valve apparatus 1 according to the disclosure is described based on a fourth exemplary embodiment (FIGS. 6-16).

Unless otherwise described, the valve apparatus 1 according to the fourth exemplary embodiment of the disclosure corresponds to the valve apparatus 1 according to the third exemplary embodiment. Identical technical features bear the same reference numerals.

The valve apparatus 1 comprises a covering side 8 and a connecting side 9.

The valve device further comprises a base body 2 consisting of a first part 22 and a second part 23, which are connectable to one another.

The first part 22 of the base body 2 is also configured in two parts, wherein the two parts of the base body 2 are connected to one another via a hinge 27, in particular a film hinge, in the region of the connecting side 9.

The base body 2 comprises a frame 28 or is configured in a frame-like manner. This frame 28 is configured so as to receive a valve device 17.

Furthermore, the base body 2 comprises a casing wall 29, wherein a first flange portion 11 is molded onto the covering side of the casing wall 29, and a second flange portion 30 is molded onto the connecting side.

The second flange portion 30 comprises insertion recesses so that the flange portion, in the region of the hinge 27, is approximately triangular from an aerial perspective and, on the two other sides, is approximately rectangular so that the base body 2, when in the folded state, can be connected to a first component 4 and a second component 6 or a first degassing opening 5 of the first component 4 and a second degassing opening 7 of the second component 6.

On an inner surface 31 of the casing wall 29, six catching elements 32 are formed on two opposite long sides of the base body 2 for connecting to the second part 23 and the valve device 17.

The valve device 17 is also approximately rectangular in shape and also has a valve frame 33 that bounds the gas passageway 14.

Catching recesses 36 arranged on an outer surface 34 of the valve frame are configured so as to correspond to the catching elements 32.

In the region between the connecting side 9 and the covering side 8, the catching recesses comprise, for example, three catching steps 37 for locking with the catching elements 32 at different heights. In this way, a tolerance compensation between the first component 4 and the second component 6 is possible.

A stiffening strut 38 is arranged in the valve frame 33 of the valve device 17. Furthermore, the membrane 18 is molded onto the covering side of the frame 32.

In the region of the outer casing wall 10 of the casing wall 29 of the base body 2, a first connecting portion 13 is formed. In the region of the first connecting portion 13, a soft component 19 is provided in a radially circumferential manner.

The soft component 19, which is arranged radially circumferentially in the first connecting portion, is used for sealingly connecting to the second component 6 or an inner casing wall of the second degassing opening 7 of the second component.

The soft component 19 is also arranged on the valve frame 33 of the valve device 17 on the connecting side, such that a second connecting portion 12 for sealingly connecting to an edge of the first component that bounds the first degassing opening.

In the region between the valve frame 33 and the casing wall 29 of the base body, a third connecting portion 21 is formed, in which the soft component 19 is also provided in order to connect the valve frame 33 or the second part 23 or the valve device 17 to the first part 22 of the base body 2.

Furthermore, according to the present disclosure, a method for assembling a valve apparatus as described above is provided. It comprises the following steps: placing a folded base body on a covering side of a second degassing opening of a second component, subjecting the base body to a compressive force acting in the direction of the connecting side, and thereby unfolding and introducing a base body into a first degassing opening of a first component and into the second degassing opening of the second component, inserting the valve device into a gas passageway of the base body, and locking the valve device to the base body.

### LIST OF REFERENCE NUMERALS

1 Valve apparatus
2 Base body
3 Means for sealing connection
4 First component
First degassing opening
6 Second component
7 Second degassing opening
8 Covering side
9 Connecting side
Outer casing wall
11 Flange portion
12 Second connecting portion
13 First connecting portion
14 Gas passageway
Inner casing wall
16 Edge
17 Valve device
18 Membrane
19 Soft component
20 Channel structure
21 Third connecting portion
22 First part
23 Second part
24 Connecting region
25 Groove/spring connection
27 Hinge
28 Frame
29 Casing wall
30 Second flange portion
31 Inner surface
32 Catching element
33 Valve frame
34 Outer surface
36 Catching recess
37 Catching step
38 Stiffening struts
40 Valve apparatus
41 First component
42 First degassing opening
43 Second component
44 Second degassing opening
45 Base body
46 Valve element
47 Securing element
48 Connecting side
49 Covering side
50 Inner casing wall
51 Outer casing wall
52 Axial direction
53 Securing recess
54 First insertion chamfer
55 Connecting portion
56 Third sealing portion
57 third sealing lip
58 Second sealing portion
59 Second sealing lip
60 Pressurization portion
61 First sealing portion
62 First sealing lip
63 Undercut element
64 Passageway
65 Valve passageway opening
66 Valve device
67 Stiffening struts
68 Undercut receptacle
69 Covering portion
70 Latch portion
71 Second insertion chamfer
72 Final assembly position
73 Pin
74 Pin receptacle
75 Valve apparatus
76 Casing wall
77 Bursting element
78 Recess
79 Collar
80 Axial direction
81 First sealing lip
82 Second sealing lip
83 Connecting wall
84 Valve apparatus
85 First component
86 First degassing opening
87 Second component
88 Second degassing opening
89 Base body
90 Valve element
91 Sealing device
92 Securing element
93 Connecting side
94 Covering side
95 Inner casing wall
96 Outer casing wall
97 Connecting recess
98 Passageway
99 Insertion slope
100 First sealing portion
101 Second sealing portion
102 Membrane
103 Stiffening struts
104 Connecting portion
105 Securing arm
106 Securing edge
107 Final assembly position
108 Sealing element
109 Radial sealing lips
110 Axial sealing lip

What is claimed is:

1. A valve apparatus (40) comprising;
a base body (45) formed from a soft component and having a first sealing portion (61) for sealing against a first component (41) and a connecting-sealing portion for sealing and connecting to a second component (43), and wherein the base body (45) bounds a passageway (64) and comprises a covering side (49) and a connecting side (48);
a valve element (46), wherein the valve element (46) is arranged in the region of the passageway (64) of the base body (45); and
a securing element (47) formed from a hard component and having a latch portion (70), wherein, in a final assembly position (72), the latch portion (70) is received in the base body (45) so as to limit at least a movement of a connecting portion (55) of the connecting-sealing portion of the base body (45) radially inwards in order to thereby secure the final assembly position (72) of the valve apparatus (40).

2. The valve apparatus (40) according to claim 1, wherein the valve apparatus (40) is free of connecting means.

3. The valve apparatus (40) according to claim 1, wherein the valve element (46) is connected to the base body (45), wherein the valve element (46) made from a hard component bounds a gas passageway that is covered by a valve device (66) of the valve element (46) formed from a soft component and connected to the valve element (46), wherein the valve device (66) is a degassing valve.

4. The valve apparatus (40) according to claim 1, wherein the valve element (46) is connected to the base body (45) in a form-fit manner via undercuts and preferably in a material-locking manner, wherein this connection is established via a 2-component injection molding process.

5. The valve apparatus (40) according to claim 1, wherein the connecting-sealing portion comprises the connecting portion (55) as well as a second and a third sealing portion (58, 56) for sealing on the connecting side and on the covering side against an edge of a second component (43) bounding an opening for receiving the valve apparatus (40).

6. The valve apparatus (40) according to claim 1, wherein a radially circumferential securing recess (53) extending approximately in the axial direction (52) is formed in a casing wall of the base body (45), wherein the securing recess (53) is bounded radially outward by a connecting wall, which comprises on its outer side the connecting portion (55) for abutting and connecting to a second component (43), and wherein the latch portion (70) of the approximately annular securing element (47) likewise extends in the axial direction (52) and, in the final assembly position (72), is arranged in the securing recess (53).

7. The valve apparatus (40) according to claim 1, wherein pins (73) extending in the axial direction (52) and pin recesses formed correspondingly on the securing element (47) are molded onto the valve element (46), or vice versa, in order to connect the securing element (47) to the valve element (46) in a form-fit manner and to fix it in the final assembly position (72).

8. The valve apparatus (40) according to claim 7, wherein the second sealing portion (58) of the base body (45) comprises on the connecting side a second sealing lip (59) that extends radially outward and is radially circumferentially molded onto the base body (45) and is structurally configured so that, in the final assembly position (72), it is pressed in a sealing manner against an edge of the second component (43) on the connecting side upon being subjected to a pressure prevailing within the first component (41).

9. The valve apparatus (40) according to claim 7, wherein the third sealing portion (56) of the base body (45) comprises on the covering side a third sealing lip (57) that extends radially outward and is radially circumferentially molded onto the base body (45) and is structurally configured so that, in the final assembly position (72), it sealingly abuts the edge of the second component (43) on the covering side with a predetermined force.

10. The valve apparatus (40) according to claim 7, wherein the first sealing portion (61) of the base body (45) comprises on the connecting side a second sealing lip (59) that extends radially outward and is radially circumferentially molded onto the base body (45) and is structurally configured so that, in the final assembly position (72), it sealingly abuts the first component (41) on the connecting side with a predetermined force.

11. The valve apparatus (40) according to claim 7, wherein the valve apparatus (40) is rectangular or oval or elliptical or round or polygonal in configuration.

12. A battery case having a valve apparatus (40) according to claim 1, comprising a housing having a bottom wall and a second degassing opening (44) and a cell having a first degassing opening (42), wherein the valve apparatus (40) is sealingly connected by a first sealing portion (61) to an edge of the cell bounding the first degassing opening (42) and is sealingly connected by a second and a third sealing portion (58, 56), as well as by a connecting portion (55), to an edge of the housing bounding the second degassing opening (44).

13. A method for disassembling a valve apparatus (40) according to claim 1, comprising the following steps:
inserting a base body (45) on the covering side into a second degassing opening (44) of a second component (43),
introducing a latch portion (70) of a securing element (47) into a securing recess (53) of the base body (45) in order to thereby limit at least a movement of a connecting portion (55) of the base body (45) in a radially inward direction, and to subject the connecting portion (55) to a radially outward acting force such that a final assembly position (72) of the valve apparatus (40) is secured.

14. The valve apparatus (40) according to claim 1, wherein the valve apparatus (40) is free of catching means for connecting to one of the components.

15. The valve apparatus (40) according to claim 3, wherein the degassing valve is a burst valve having a membrane.
